(19) United States
(12) Patent Application Publication
(10) Pub. No.: US 2024/0000036 A1
(43) Pub. Date: Jan. 4, 2024

(54) MILKING TEATCUP, TEATCUP SHELL, AND INFLATION OF A MILKING SYSTEM

(71) Applicant: I B A, Inc., Sutton, MA (US)

(72) Inventors: Alan B. Coates, Sun Prairie, WI (US); Lennart G. Petersson, Douglas, MA (US)

(21) Appl. No.: 18/134,818

(22) Filed: Apr. 14, 2023

Related U.S. Application Data
(60) Provisional application No. 63/331,341, filed on Apr. 15, 2022.

(51) Int. Cl. A01J 5/06

(52) U.S. Cl. CPC A01J 5/06

(57) ABSTRACT

A lightweight teatcup for use with a milking machine is described herein. The teatcup includes a teatcup shell having two ridges circumferentially spaced apart on the exterior of the body portion of the teatcup shell. The ridges extend along less than the length of the milking teatcup shell. Excluding the ridges, the outside diameter of the teatcup shell of the teatcup is significantly narrower than a diameter of comparable existing milking teatcup shells, hence this milking inflation and shell has a positive impact on the ergonomic factors.

### CROSS-REFERENCE TO RELATED APPLICATIONS

This application claims the benefit of U.S. Provisional Patent Application Ser. No. 63/331,341, filed on Apr. 15, 2022, entitled “Teatcup Shell for Inflation of a Milking System,” the entire content of which is hereby incorporated by reference herein in its entirety.

### BACKGROUND

As the dairy industry continues to grow, and the average herd size is increasing, the demands on milking systems and workers operating the milking systems are also increasing, which can make it difficult to optimize and/or complete the daily milking of cows. With the limited time for performing proper procedure for each and every animal, it is important that the workers have equipment that makes the task easier to complete. Additionally, the physical demands on each individual conducting the milking create serious limitations when it comes to the factor of reasonable ease as that relates to ergonomics. It is important that the milking equipment is comfortable for the user to prevent fatigue and/or injuries that would hinder the productivity of the worker. In a typical dairy operation, there will be three milkings each twenty-four hour period. Relative to fatigue the physical stress tends to be elevated which can cause a reduction in performance.

In addition, in many regions, milkers tend to be of smaller stature with smaller hands. Known milking equipment, however, is not particularly designed or optimized for such milkers.

### SUMMARY

There is a need for a teatcup, and teatcup shell, that is ergonomic, lightweight, comparatively smaller (at least in outside diameter and/or circumference) to known teatcups and teatcup shells.

There is a need for a teatcup and teatcup shell having improved and/or optimally positioned ribs or ridges for the hand, handline and/or comfort of a user using the teatcup. Further, there is a need for a teatcup and teatcup shell having improved and/or optimally positioned ribs or ridges that help a user position and/or maneuver a teatcup relative to a teat.

Accordingly, disclosed and described herein is an ergonomic milking teatcup and shell, and a liner, that may make the process of milking, and in particular coupling or connecting and/or decoupling or disconnecting the milking machine to and from a teat of a cow (or other lactating animal), easier and may also reduce fatigue and/or injuries to the user. Specifically, the teatcup shell and, in particular, the body portion of the shell, includes a relatively smaller diameter (e.g., outside diameter) or cross-section to better, or more optimally, comfortably or naturally, fit or fit in a person's or typical user's hand. Additionally, the teatcup shell includes ridges spaced to fit at approximately the finger bend areas (e.g., finger joints) of the person's hand. Because the teatcup shell fits better in the user's hand, repetitive injuries, such as carpal tunnel, may be reduced, thus decreasing down time of the workers due to injury. Thus, teatcup shell described herein is an overall improvement in comfort for the individual doing the milking, which results in less injury to the individual, reduces fatigue and stress, and increases performance (e.g., speed of completing the task of attaching the teatcup to a teat) of an individual animal. For example, a milker's or user's performance can positively or negatively affect oxytocin release and milk let down, and timely preparation of teats of lactating animals will improve oxytocin release, milk letdown and overall performance and health of the mammary gland. Accordingly, the teatcup and shell disclosed herein includes physical features and factors likely to overcome limitations (e.g., with typical procedures) that may negatively affect the overall performance and possibly oxytocin release.

Accordingly, also disclosed herein is teatcup that is comparatively lighter in weight. Comparative weight of a milking claw including the disclosed teatcups is thus also remarkably lighter than that of known milking units.

Accordingly, a teatcup shell for use with a milking machine is provided, comprising: a teatcup shell having body portion, the body portion having a length; and a ridge on the body portion, the ridge extending along less than the length of the body portion.

Accordingly, a teatcup for use with a milking machine is also provided, comprising: a teatcup shell having body portion, the body portion having a length; and a ridge on the body portion, the ridge extending along less than the length of the body portion; and a triangular-shaped inflation connected internally to the teatcup shell. It is desirable to have a certain tension on the inflation by stretching it when it is inserted in the body portion of the teatcup shell.

### BRIEF DESCRIPTION OF THE DRAWINGS

Various examples of embodiments of the systems, devices, and methods according to this invention will be described in detail, with reference to the following figures:

FIG. 1 illustrates a perspective view of a teacup, including a teatcup shell and inflation, according to various examples of embodiments;

FIG. 2 illustrates a first perspective side view of a teatcup shell, according to various embodiments;

FIG. 3 illustrates a second perspective side view of the teatcup shell of FIG. 2, according to various embodiments;

FIG. 4 illustrates a third perspective side view of the teatcup shell of FIG. 2, according to various embodiments;

FIG. 5 illustrates a fourth perspective side view of the teatcup shell of FIG. 2, according to various embodiments;

FIG. 6 illustrates a first partial perspective view of a user's hand holding the teatcup shell of FIG. 2, according to various embodiments;

FIG. 7 illustrates a second partial perspective view of a user's hand holding the teatcup shell of FIG. 2, according to various embodiments;

FIG. 8 illustrates a perspective view of the bottom or first end of the teatcup shell of FIG. 2, according to various embodiments;

FIG. 9 illustrates a perspective view of the top or second end of the teatcup shell of FIG. 2, according to various embodiments;

FIG. 10 illustrates a detailed side perspective view of a stainless steel collar and head portion of the milking teatcup shell of FIG. 2, according to various embodiments;

FIG. 11 illustrates a first side view of a teatcup shell without a collar, according to various embodiments;

FIG. 12 illustrates a second side view of the teatcup shell of FIG. 11, according to various embodiments;

FIG. 13 illustrates a bottom view of the teatcup shell of FIG. 11, according to various embodiments;

FIG. 14 illustrates a top view of the teatcup shell of FIG. 11, according to various embodiments;

FIG. 15 illustrates a sectional view of the teatcup shell illustrated in FIG. 14 taken along the cross-section 15:15 of FIG. 14, according to various embodiments;

FIG. 16 illustrates a detailed sectional view of section 16 of the sectional view of the teatcup shell of FIG. 15, according to various embodiments;

FIG. 17 illustrates a cross-sectional view of the teatcup shell of FIG. 12 taken along the cross-section 17:17 of FIG. 12, according to various embodiments;

FIG. 18 illustrates a first side view of an inflation that may be used with (e.g., in combination with) the teatcup shell of FIGS. 2-17 to form a teatcup, according to various embodiments;

FIG. 19 illustrates a second side view of the inflation of FIG. 18, according to various embodiments;

FIG. 20 illustrates a third side view of the inflation of FIG. 18, according to various embodiments;

FIG. 21 illustrates a top view of the inflation of FIG. 18 showing, among other things, a mouthpiece opening defined in a mouthpiece depicting a circle of hexagons;

FIG. 22 illustrates a cross-sectional view of the inflation of FIG. 18 taken along the cross-section 22:22 of FIG. 18, according to various embodiments;

FIG. 23 illustrates a cross-sectional view of the inflation of FIG. 18 taken along the cross-section 23:23 of FIG. 18, according to various embodiments;

FIG. 24 illustrates a cross-sectional view of the inflation of FIG. 21 taken along the cross-section 24:24 of FIG. 21, according to various embodiments;

FIG. 25 illustrates a cross-sectional view of the inflation of FIG. 19 taken along the cross-section 25:25 of FIG. 19, according to various embodiments;

FIG. 26 illustrates a cross-sectional view of the inflation of FIG. 21 taken along the cross-section 26:26 of FIG. 21, according to various embodiments; and

FIG. 27 illustrates a detailed sectional view of section 27 of the side view of the teatcup shell of FIG. 19, according to various embodiments.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION

One or more specific embodiments of a milking teatcup, teatcup shell and inflation are disclosed and described herein. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

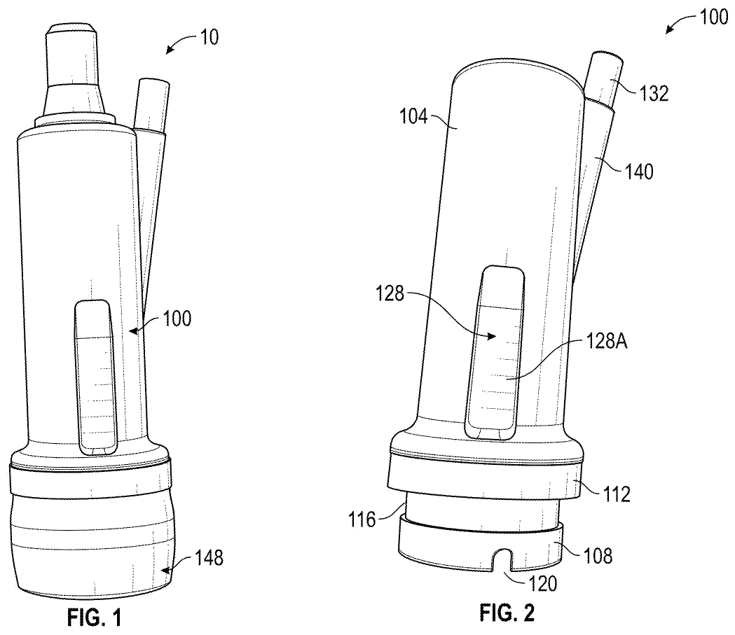

FIG. 1 depicts a perspective view of a milking teatcup 10. In various embodiments, teatcup 10 includes a teatcup shell 100 and an inflation or liner 148. In various embodiments, teatcup 10 is designed for use with a milking system (not shown) and may be used in place of known teatcups of the milking system.

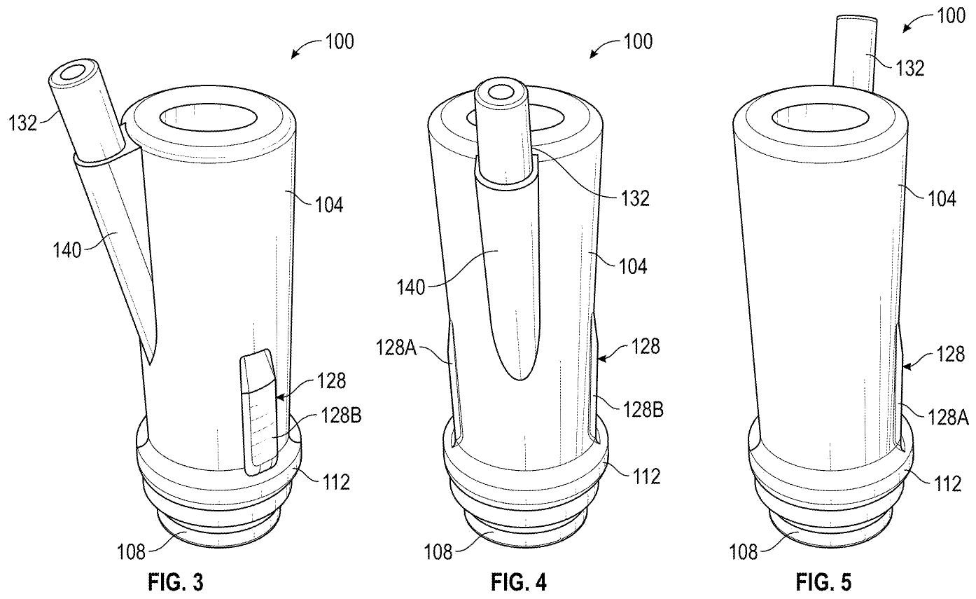

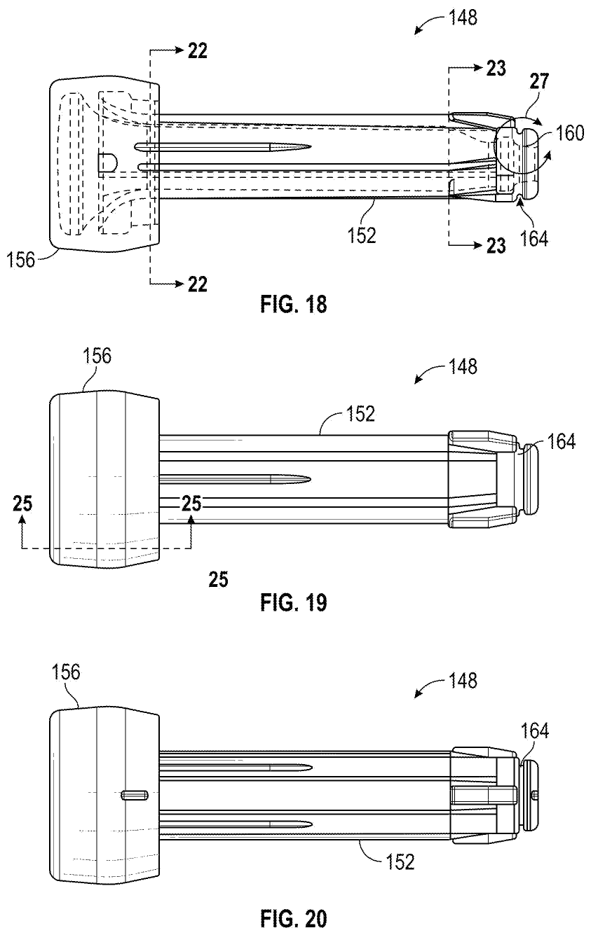

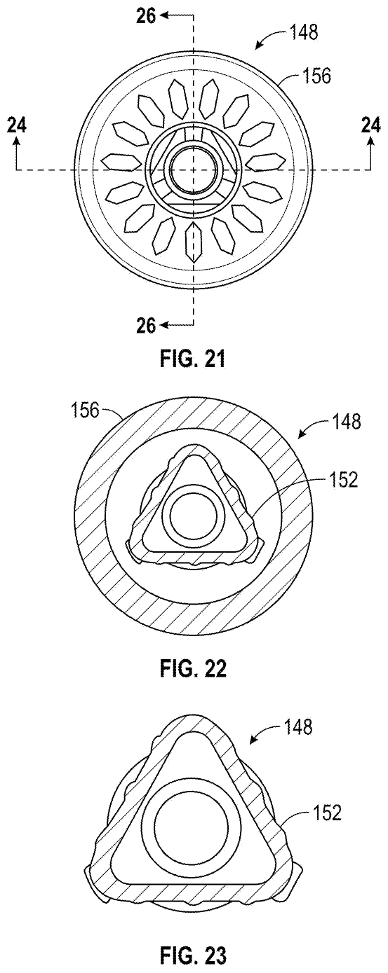

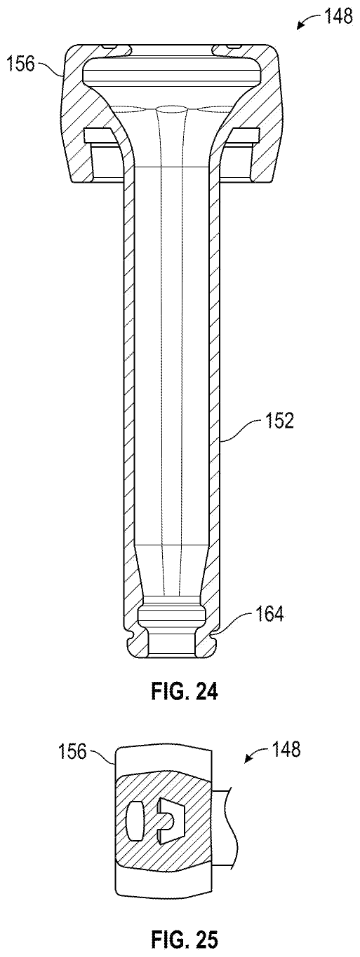

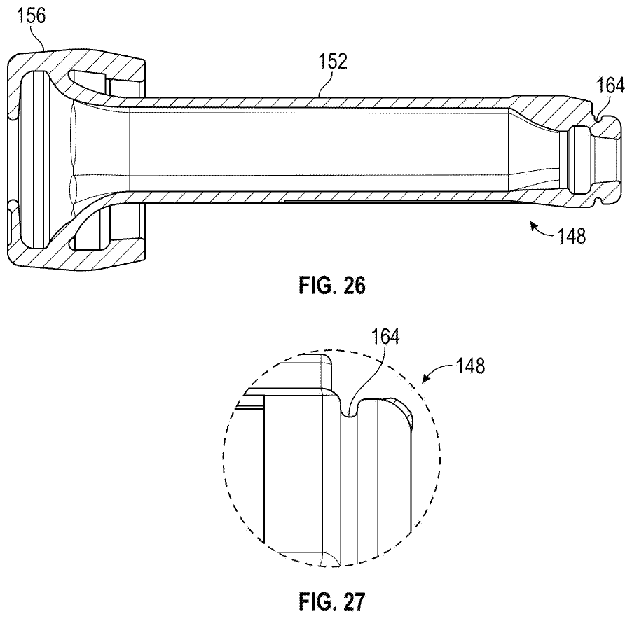

FIGS. 2-5 depict a various perspective views of a milking teatcup shell 100, according to various examples of embodiments. In various embodiments, teatcup shell 100 is designed for use with a milking system (not shown) and may be used in place of existing teatcup shells of the milking system. The teatcup shell may be used with other inflations or may be used with the example inflation described herein and illustrated in FIGS. 18-27. In various examples of embodiments, teatcup shell 100 is constructed (at least primarily or mostly) of a lightweight polymer compound to facilitate ergonomically easier use and to help ensure a long-lasting and durable teatcup shell. It should be appreciated, however, that the teatcup shell may be made of other materials and/or combinations of such materials.

As depicted in FIGS. 2-5, in various embodiments, teatcup shell 100 includes a body portion 104 and a head portion 108. In various embodiments, teatcup shell 100 also includes a collar 112 provided between head portion 108 and body portion 104. The collar may be made from stainless steel or a polymer compound to create a lighter weight teatcup shell and teatcup. In various embodiments, body portion 104, head portion 108 and collar 112 are each substantially cylindrical, with collar 112 having a larger diameter (e.g., outside diameter) than that of body portion 104 (or most of body portion 104) and head portion 108. A user may grip the body portion to attach, couple or connect a milking teatcup (including the shell) of a milking machine to a teat of a cow.

In various embodiments, head portion 108 includes one or more features (e.g., an annular indentation 116, one or more notches 120, and other anti-twist protection) to help secure or otherwise couple an inflation within and/or relative to teatcup shell 100. In various examples of embodiments, collar 112 helps separate or otherwise space body portion 104 from head portion 108 and may help keep the inflation in place in and/or relative to teatcup shell 100. In various examples of embodiments, the collar is made from a polymer material and/or stainless steel to provide different weights of the liner/teatcup shell combination and/or to provide desired different liner/teatcup shell weight combinations.

A more detailed view of the example collar 112 and head portion 108 is depicted in FIG. 9. In various embodiments, additional features on an interior surface 124 of head portion 108 may also help retain or secure an inflation within and/or relative to teatcup shell 100.

Referring again to FIGS. 2-5, according to various examples of embodiments, teatcup shell 100 includes one or more ridges 128 (e.g., longitudinal first ridge 128A and longitudinal second ridge 128B). As shown in the figures, in various embodiments, first and second ridges 128A/128B extend (e.g., longitudinally or lengthwise) along a section of body portion 104 of teatcup shell 100. As illustrated in this example, first and second ridges 128A/128B are provided, spaced and/or placed (e.g., circumferentially provided, spaced and/or placed) on or about opposite, or opposing surfaces of, exterior portions of body portion 104 of teatcup shell 100. In various embodiments, first and second ridges 128A/128B are provided, spaced and/or placed (e.g., circumferentially provided, spaced and/or placed) on body portion 104 approximately one hundred eighty degrees (180°) apart from or relative to each other. In various embodiments, first ridge 128A and second ridge 128B are provided at or near antipodal or diametrically opposite points of the circumference or perimeter of an exterior surface of body portion 104 of teatcup shell 100. In various embodiments, first ridge 128A and second ridge 128B are centered at or near antipodal or diametrically opposite points of the circumference or perimeter of body portion 104 of teatcup shell 100.

In various embodiments, ridges 128 are spaced to more optimally, naturally or comfortably support (e.g., simultaneously support) a portion of an index finger and/or middle finger of a user, and a portion of a thumb of the user. In various embodiments, first and second ridges 128A/128B are spaced apart to more optimally, naturally or comfortably support an index and middle finger of a user over and across first ridge 128A and to more optimally support a thumb of the user over and across second ridge 128B.

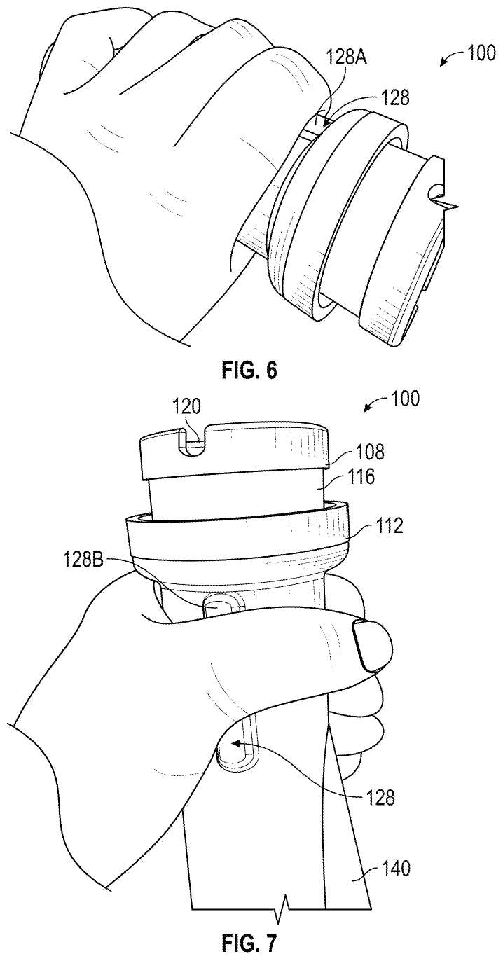

A ring finger and little finger of the user may support the teatcup shell below (i.e., towards the bottom or the body portion) or otherwise off the ridges. In various embodiments, ridges 128 of teatcup shell 100 do not extend along the entire length of body portion 104. According to various embodiments, ridges 128 are shorter than the length of body portion 104 to help teatcup shell 100 provide a more optimal, natural and/or comfortable fit within a hand of a user. FIGS. 6 and 7 depict views of a user's hand holding or gripping teatcup shell 100. As shown in FIG. 6, in various embodiments, one of ridges 128 (e.g., first ridge 128A) is positioned under or approximately under the user's second knuckle (i.e., between the proximal phalanx and the medial phalanx) of the user's index and middle fingers. Alternatively, one of the ridges may be positioned under or approximately under the user's first knuckle (i.e., between the metacarpus and the phalanges) of the index and middle fingers, depending on which position is more comfortable or desirable for the user. As shown in FIG. 7, the other of the ridges 128 (e.g., second ridge 128B) is positioned under or approximately under the user's first knuckle of the thumb. It may alternatively be positioned under or approximately under the second knuckle of the thumb, depending on the user' hand size and/or shape and desired comfort. Increased comfort for the user results in less injuries, such as carpal tunnel syndrome, and increases overall productivity of the user.

Referring now to FIGS. 2-5 and 7-8, in various examples of embodiments, teatcup shell 100 also includes an air hose connection 132 and, or coupled to, an air hose connection member 140 extending from body portion 104, to provide or allow for air movement in and out of the area between the liner and teatcup shell 100. This is to help cyclic milk flow during the milking process. Air hose connection connects or is adapted to connect to a pulsation system (not shown). Ridges 128 are circumferentially spaced from air hose connection member 140 (e.g., such that teatcup shell 100 can be held by a typical user's hand with the air hose connection member positioned outside or away, or mostly outside or away, from the user's hand (e.g., on the exterior surface of the body portion between the end of the user's thumb and ends of the user's fingers)). For example, in various embodiments, when a user is holding teatcup shell 100, air hose connection member 140 is positioned adjacent to, but not in contact with, the user's thumb (as shown in FIG. 7) to prevent the air hose connection member from making the holding or gripping of milking teatcup shell 100 less comfortable for the user. This is intended to help optimize comfort for the user or milker. In various embodiments, ridges 128 are circumferentially spaced equidistantly from air hose connection member 140. It should be appreciated that certain users may have large enough hands, or long enough fingers, to contact or even overlap the air hose connection member.

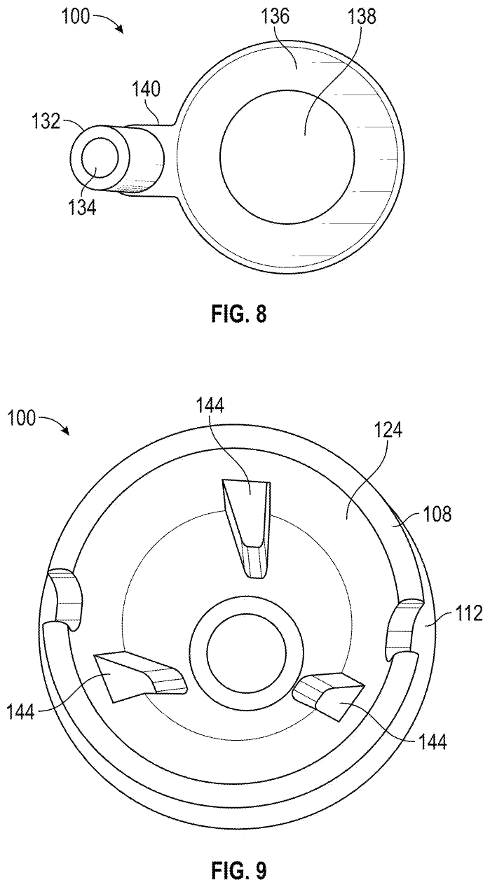

FIG. 8 depicts a bottom end view of milking teatcup shell 100 of FIGS. 2-5. Teatcup shell 100 includes a bottom end 136, which bottom end 136 defines an opening 138 for an inflation (not shown), which inflation extends out of teatcup shell 100 and is adapted to be coupled to a short milk tube through which milk may flow. Additionally shown in FIG. 8 is air hose connection 132 which defines an opening 134 or pulsator port adapted to be coupled to an air hose so that the inflation may be pulsated and/or expanded and contracted cyclically during the milking process. Without this pulsation, optimal or desired milk flow will not likely occur and teat health may be negatively impacted.

FIG. 9 depicts a top end view of teatcup shell 100 of FIGS. 2-5. As shown in FIG. 9, teatcup shell 100 includes an interior surface 124 with three substantially equally spaced notches 144. Notches 144 are positioned to correspond to the points on a triangular-shaped inflation (including the example inflation described herein) and help guide the inflation in or relative to milking teatcup shell 100 to help ensure proper placement of the inflation within teatcup shell 100. In various examples of embodiments, notches 144 help prevent twisting of a barrel section of the inflation so that the inflation is allowed to open and close properly to allow milk to continue to flow. In various embodiments, notches 144 are provided, spaced or offset about one hundred twenty (120) degrees from one another, but may be provided, spaced or offset at different ranges based on the inflation being used with the teatcup shell. Similar anti-twist notches may be implemented in different locations in various other embodiments to prevent twisting of an inflation design. For example, two notches may be needed in a teatcup shell to provide anti-twisting for square and round barreled inflations, which inflation designs collapse in a single plane. In various embodiments, the circumferential positions of notches 144 are not aligned with, or are offset from, the circumferential position of the ridges. However, the circumferential position of one or more of the notches may align with that of one or more of the ridges in other embodiments.

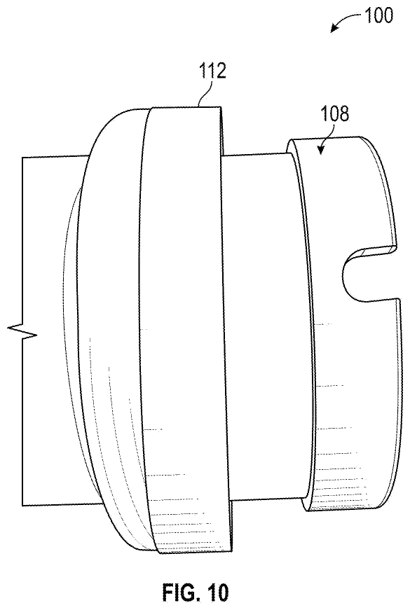

FIG. 10 illustrates a detailed side view of collar 112 and head portion 108 of milking teatcup shell 100. As illustrated, in various embodiments, collar 112 is made of stainless steel. In various embodiments, however, the collar may be made of a lightweight polymer to reduce weight and/or improve ergonomics when handling the milking teatcup shell.

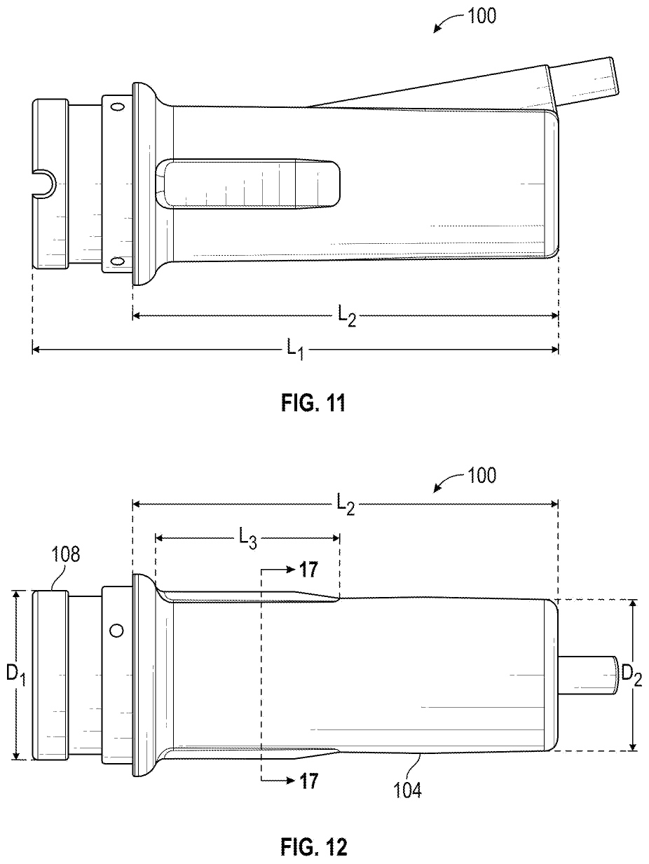

FIGS. 11 and 12 are side views of teatcup shell 100 without a collar. As illustrated, in various embodiments, teatcup shell 100 has an overall length L₁ and a body portion length L₂. In various examples of embodiments, body portion length L₂ is in a range of sixty-five percent (65%) to eighty percent (80%) of overall length L₁ of teatcup shell 100. In various examples of embodiments, body portion length L₂ is a range of seventy percent (70%) to seventy-five percent (75%) of overall length L₁ of teatcup shell 100. In various examples of embodiments, body portion length L₂ is approximately seventy-three percent (73%) of overall length L₁ of teatcup shell 100.

Referring more specifically to FIG. 12, in various embodiments, one or more ridges 128 have a ridge length L₃ In various embodiments, ridge length L₃ of one or more ridges 128 is in a range of thirty percent (30%) to seventy percent (70%) of body portion length L₂. In various embodiments, ridge length L₃ of one or more ridges 128 is in a range of forty percent (40%) to sixty percent (60%) of body portion length L₂. In various embodiments, ridge length L₃ of one or more ridges 128 is less than about fifty percent (50%) of body portion length L₂.

In various embodiments, head portion 108 of teatcup shell 100 has a head portion outside diameter D₁ and body portion 104 of teatcup shell 100 has a body portion outside diameter D₂. In various examples of embodiments, body portion outside diameter D₂ is less than head portion outside diameter D₁. In various examples of embodiments, body portion outside diameter D₂ is less than 90% of head portion outside diameter D₁. In various examples of embodiments, body portion outside diameter D₂ is about seventy percent (70%) to ninety percent (90%) of head portion outside diameter D₁. In various examples of embodiments, body portion outside diameter D₂ is about eighty-five percent (85%) of head portion outside diameter D₁.

In various embodiments, the teatcup shell disclosed herein, and more particularly the body portion of the teatcup shell, has on overall smaller diameter then known teatcup shells, which further facilitates a comfortable grip for the user. In various embodiments, the example teatcup shell is also lighter than known teatcup shells, which makes the milking teatcup shell easier to maneuver to attach to a teat of a cow and may result in less repetitive stress injuries, such as carpal tunnel syndrome, or other injuries of the user's wrist, hands, or fingers.

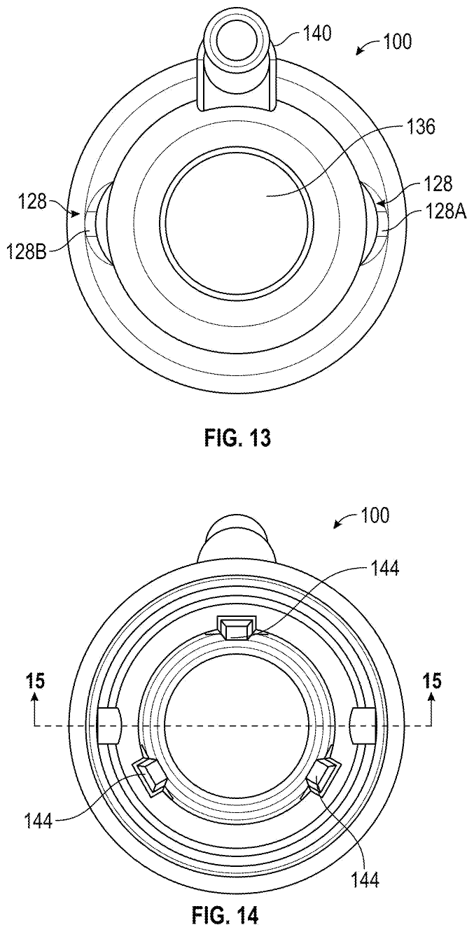

Referring now to FIG. 13, ridges 128 (or first ridge 128A and second ridge 128B) are spaced or offset approximately one hundred eighty degrees (180°) from one another circumferentially around the teatcup shell 100. In various embodiments, ridges 128 are spaced or offset (e.g., circumferentially) in a range of about one hundred fifty degrees (150°) to about one hundred ninety degrees (190°) from one another. In various embodiments, ridges 128 are spaced or offset (e.g., circumferentially) in a range of about one hundred twenty degrees (120°) to about two hundred degrees (200°) from one another. As illustrated, air hose connection member 140 is offset from each of ridges 128 approximately ninety degrees (90°). However, in various embodiments, air hose connection member 140 is offset from about seventy-five degrees (75°) to about one hundred fifteen degrees (115°) from at least first ridge 128A or second ridge 128B. In various embodiments, air hose connection member 140 is offset from about fifty degrees (50°) to about one hundred forty degrees (140°) from at least first ridge 128A or second ridge 128B. In various embodiments, air hose connection member 140 is offset from about thirty degrees (30°) to about one hundred seventy degrees (170°) from at least first ridge 128A or second ridge 128B.

FIG. 14 depicts a top end view of teatcup shell 100 of FIG. 11. As shown in FIG. 9, teatcup shell 100 defines three substantially equally spaced notches 144. Notches 144 are positioned to correspond to the points on a triangular-shaped inflation (including the example inflation described herein) and help guide the inflation in or relative to milking teatcup shell 100 to help ensure proper placement of the inflation within teatcup shell 100. In various examples of embodiments, notches 144 help prevent twisting of a barrel section of the inflation so that the inflation is allowed to open and close properly to allow milk to continue to flow. In various embodiments, notches 144 are provided, spaced or offset about one hundred twenty degrees (120°) from one another, but may be provided, spaced or offset at different ranges based on the inflation being used with the teatcup shell. Similar anti-twist notches may be implemented in different locations in various other embodiments to prevent twisting of an inflation design. For example, two notches may be needed in a teatcup shell to provide anti-twisting for square and round barreled inflations, which inflation designs collapse in a single plane. In various embodiments, the circumferential positions of notches 144 are not aligned with, or are offset from, the circumferential position of the ridges. However, the circumferential position of one or more of the notches may align with that of one or more of the ridges in other embodiments.

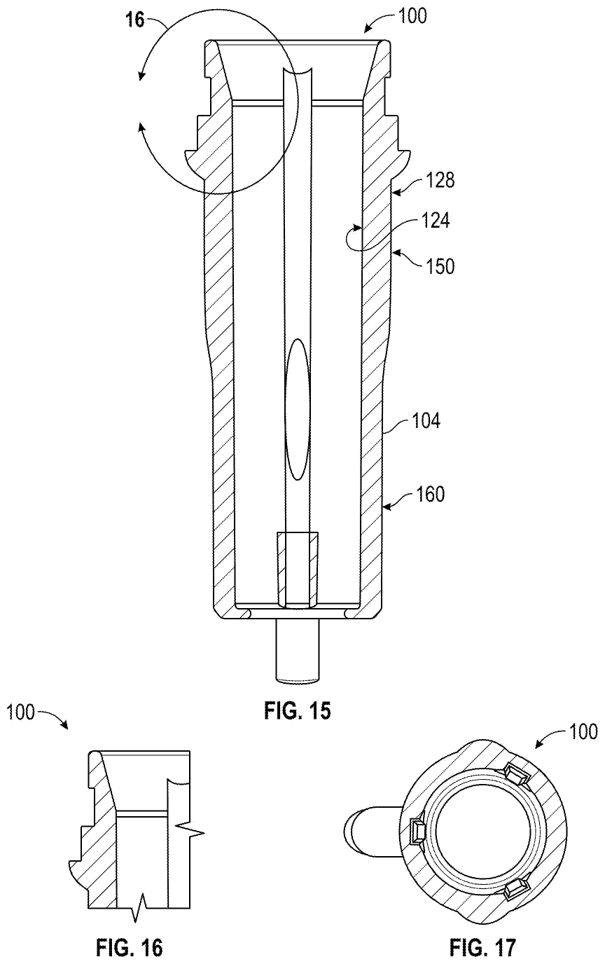

FIG. 15 is a cross-sectional view of teatcup shell 100 taken along the cross-section 15:15 of FIG. 14. FIG. 16 is a detailed view of section 16 of teatcup shell 100 of FIG. 15. FIG. 17 is a cross-sectional view of teatcup shell 100 taken along the cross-section 17:17 of FIG. 12. As shown in the FIGS. 15 and 16, where ridges 128 are provided the material or wall forming teatcup shell 100 (e.g., that material between interior surface 124 and a ridge exterior surface 150) is thicker (e.g., than that between interior surface 124 and exterior surface 160 of body portion 104) due at least in part to additional material forming ridges 128. Teatcup shell, however, includes an interior circumference or surface 124 that, in various embodiments, is substantially constant or consistent along the length (or at least most of the length) of body portion 104 of teatcup shell 100, or around the cross-section illustrated in FIG. 17, except for interior notches. Referring now to FIG. 16, near or at the top end of teatcup shell 100, adjacent to head portion 108, interior circumference or surface 124 of teatcup shell 100 is tapered, which may make teatcup shell 100 easier to couple to an inflation and/or a teat.

FIGS. 18-27 depict an example inflation 148 that may be used with the example teatcup shell disclosed herein. Alternatively, other inflations may be used with the example teatcup shell. Such an example inflation is that disclosed in U.S. Pat. No. 6,701,865, the entirety of which is incorporated by reference herein. In various embodiments, inflation 148 includes a body portion 152 corresponding at least in several respects to the body portion of the disclosed example teatcup shell. In various embodiments, body portion 152 of inflation 148 fits within the body portion of the disclosed milking teatcup shell. In the illustrated example, body portion 152 of liner or inflation 148 has a substantially triangular cross-section (e.g., is a triangular shaped inflation). However, the body portion may be other cross-sectional shapes. FIGS. 22 and 23 depict cross-sectional views of inflation 148 at sections 22:22 and 23:23 of FIG. 18, respectively, which illustrate the triangular shape of inflation 148. Liners collapsing in single planes may not optimally fit in the disclosed embodiments of the example teatcup shell. This is at least partially due to the dimensional changes during the collapse of the liner during milking. The movement of each corner of a triangular barreled inflation during collapse is mostly negligible compared to that of a round or square barrel inflation, where two opposing corners (or sides for a round inflation) expand during collapse of the inflation. In various embodiments, the distance from the inner wall of a shell of a teatcup including the triangular liner to one of the three corners is slightly shorter during the collapse of the liner than when the liner is in its natural or typical placement. In various embodiments, this shortened distance allows for a narrower and/or lighter weight shell. In various embodiments, triangular liners are used in connection with the teatcup shells disclosed herein due to such differences in the way barrels of triangular liners collapse as compared to other liners.

In various embodiments, liner or inflation 148 also has a head portion or a mouthpiece 156 defining a mouthpiece opening at one end that corresponds to the head portion of the teatcup shell. In various embodiments, head portion or mouthpiece 156 of liner or inflation 148 fits over the head portion of the teatcup shell. In various examples of embodiments, liner or inflation 148 includes an annular groove 164 (shown in FIG. 27 in detail) to facilitate connection of liner 148 to the inner portion of the teatcup shell. In various embodiments, a connector made from a clear polymer is inserted into the liner via the mouthpiece opening in the top of the liner, via an internal barrel defined in the body portion of the liner and pushed thru an opening defined in a bottom end of the liner or inflation. A bottom end of the connector includes an exterior portion that is adapted to be coupled to a short milk hose coupled to a milking claw. The milking claw facilitates collection of milk from four teats or quarters of an animal (e.g., a lactating dairy animal) and subsequently transfers the milk into an internal portion of the milking system.

In various embodiments, inflation or liner 148 is sized to fit within the disclosed example teatcup shell. Because the example teatcup shell has an overall smaller diameter at the body portion of the milking teatcup shell in various example embodiments, the body portion of the inflation may also have a smaller diameter. However, the body portion of the inflation does not necessarily need to have a smaller diameter.

One or more of the disclosed embodiments, alone or in combination, may provide one or more technical effects including the increased comfort of the user connecting the teatcup shells of a milking machine to the teats of lactating animals. Improved comfort for the user results in less injury and increased productivity. The technical effects and technical problems in the specification are exemplary and are not limiting. It should be noted that the embodiments described in the specification may have other technical effects and can solve other technical problems.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only, and not limiting. Although only a few embodiments have been described in detail in this disclosure, those skilled in the art who review this disclosure will readily appreciate that many various alternatives, modifications, variations, improvements and/or substantial equivalents, whether known or that are or may be presently foreseen, are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes, and omissions may be made in the design, operating conditions, and arrangement of the various examples of embodiments without departing from the spirit or scope of the present inventions. Therefore, the invention is intended to embrace all known or earlier developed alternatives, modifications, variations, improvements and/or substantial equivalents.

The technical effects and technical problems in the specification are exemplary and are not limiting. It should be noted that the embodiments described in the specification may have other technical effects and can solve other technical problems.

We claim:

1. A teatcup shell for use with a milking machine comprising:
a teatcup shell having body portion, the body portion having a length; and
a ridge on the body portion, the ridge extending along less than the length of the body portion.

2. The teatcup shell of claim 1, wherein the ridge is a first ridge, and further comprising a second ridge, the second ridge extending along less than the length of the body portion.

3. The teatcup shell of claim 2, wherein the second ridge is circumferentially spaced between one hundred twenty and two hundred degrees from the first ridge.

4. The teatcup shell of claim 2, wherein the second ridge is circumferentially spaced one hundred eighty degrees from the first ridge.

5. The teatcup shell of claim 1, further comprising a collar, wherein the ridge extends from the collar.

6. The teatcup shell of claim 2, further comprising a collar, wherein the first ridge and the second ridge each extend from the collar.

7. The teatcup shell of claim 1, further comprising an air hose connection member extending from the body portion, wherein the air hose connection member is circumferentially spaced between seventy-five and one hundred fifteen degrees from the ridge.

8. The teatcup shell of claim 6, wherein the air hose connection member is circuferentially spaced ninenty degrees from the ridge.

9. The teatcup shell of claim 2, further comprising an air hose connection member extending from the body portion, wherein the air hose connection member is circumferentially spaced ninety degrees from the first ridge and the second ridge.

10. The teatcup shell of claim 1, the teatcup shell having an interior surface with three notches defined therein, wherein the notches are circumferentially spaced one hundred twenty degrees apart.

11. The teatcup shell of claim 9, the teatcup shell having an interior surface with three notches defined therein, wherein the notches are circumferentially spaced one hundred twenty degrees apart.

12. A teatcup for use with a milking machine comprising:
a teatcup shell having body portion, the body portion having a length; and
a ridge on the body portion, the ridge extending along less than the length of the body portion; and
a triangular-shaped inflation connected internally to the teatcup shell.

13. The teatcup of claim 12, wherein the ridge is a first ridge, and further comprising a second ridge, the second ridge extending along less than the length of the body portion.

14. The teatcup of claim 13, wherein the second ridge is circumferentially spaced one hundred eighty degrees from the first ridge.

15. The teatcup of claim 14, further comprising a collar, wherein the first ridge and the second ridge extends from the collar.

16. The teatcup of claim 14, further comprising an air hose connection member extending from the body portion, wherein the air hose connection member is circumferentially spaced ninenty degrees from the first ridge and the second ridge.

17. The teatcup of claim 12, the teatcup shell having an interior surface with three notches defined therein, wherein the notches are circumferentially spaced one hundred twenty degrees apart.

18. The teatcup shell of claim 16, the teatcup shell having an interior surface with three notches defined therein, wherein the notches are circumferentially spaced one hundred twenty degrees apart.

19. A milking machine comprising the teatcup of claim 12.
